(19) United States
(12) Patent Application Publication
(10) Pub. No.: US 2007/0193058 A1
(43) Pub. Date: Aug. 23, 2007

(54) Drying cabinet and ventilation system

(76) Inventor: Thomas P. Zarembinski, Vadnais Heights, MN (US)

Correspondence Address: JANET PEYTON SCHAFER;SCHAFER LAW OFFICE, P.A., 727 TORCHWOOD CIRCLE, NEW BRIGHTON, MN, 55112, US

(21) Appl. No.: 11/600,358

(22) Filed: Nov. 16, 2006

Related U.S. Application Data
(60) Provisional application No. 60/776,031, filed on Feb. 23, 2006.

(51) Int. Cl. F26B 25/06

(52) U.S. Cl. 34/202

(57) ABSTRACT

Air circulating apparatus for providing ventilation within a drying cabinet and locker having an intake air flow fan and a circular-shaped air ducting system for producing cyclonic air flow within the locker for enhancing the drying and deodorizing of clothing and sporting equipment not easily laundered for use in an equipment locker, closet or the like. The air circulating apparatus having a small sized intake air fan, a charcoal filter element activated by the air flow, a timing circuit permitting the fan to be set for a selected period of time, and a circular-shaped air ducting system having a series of angled baffles for directing air flow upwardly. The air circulating apparatus having an alternative aromatic structure for release of oil compounds upon exposure of the aromatic structure to air flow. The air circulating apparatus used in conjunction with a cabinet and locker, or the like where malodorous odors congregate.

### BACKGROUND

The present invention is directed generally to apparatus for air circulation in a confined space. In particular, the present invention relates to a drying cabinet or locker with apparatus to facilitate air circulation which enhances drying and deodorizing clothing articles and sports equipment contained therein.

Sporting equipment that cannot be easily laundered, such as skates, helmets, pads, hunting equipment and the like, may become offensively odoriferous with repeated wearing. Additionally, retained moisture can also be a problem. Keeping sporting equipment dry and odor free is one of the main difficulties associated with many sporting or recreational activities. Equipment bags trap in moisture, which makes them an ideal breeding ground for bacteria, mold, mildew and fungus. These contaminants are the real culprit behind equipment odor and in addition to being unpleasant, they pose a variety of health risks.

Drying chambers exist which dry clothing. Many are ventilation or drying cabinets, some with a heating element, such as Hill U.S. Pat. No. 6,018,885 and Hutchinson U.S. Pat. No. 1,752,797; some with a fan such as Benjamin U.S. Pat. No. 3,670,425; some with filters, ex. Charcoal filter of Dhaemers U.S. Pat. No. 5,546,678 and U.S. Pat. No. 5,369,892. These two Dhaemers patents also have tube elements to deflect or direct air into boots and the like. Ou U.S. Pat. No. 5,755,040 uses diffusion plates.

### SUMMARY

The present invention provides a drying cabinet or locker that includes a permanently installed and timer controlled intake air flow fan and an air ducting system for producing cyclonic air flow within the cabinet or locker as air circulation means, which enhances drying and deodorizing clothing articles and sports equipment, and a duct system for promoting a cyclonic flow of air through the locker apparatus. An alternative embodiment includes an optional heating element, an optional fragrance element and optional supplemental booster fans.

### BRIEF DESCRIPTION OF THE DRAWINGS

Understanding of the invention will be enhanced by referring to the accompanying drawings, in which like numbers refer to like parts in the several views and in which:

FIG. 1 is a left side elevational view of the primary invention in an individual cabinet or locker;

FIG. 2 is a cross-sectional view, taken along lines 2-2 in FIG. 1;

FIG. 3 is a cross-sectional view of the duct system with a left side air intake, taken along the lines 3-3 in FIG. 2;

FIG. 4 is a view similar to that of FIG. 2 of the interior of the cabinet or locker, with air flow indicated by arrows;

FIG. 5 is a side elevational section view of the air flow fins taken along line 5-5 in FIG. 3;

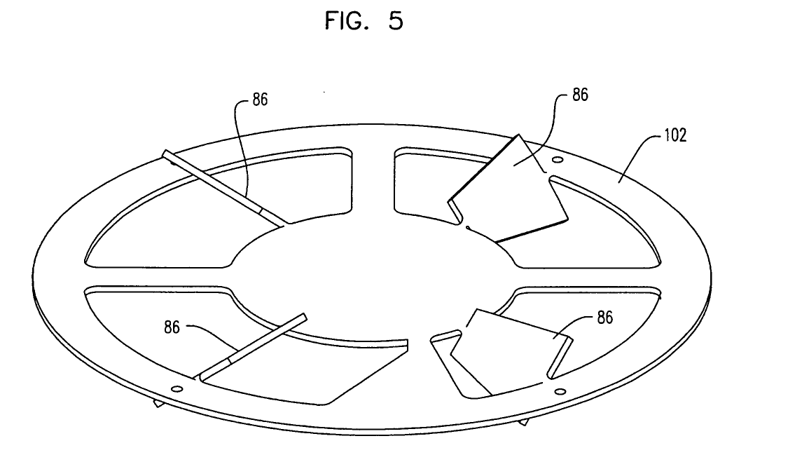

FIG. 6 is a fragmentary side elevational section view along line 6-6 in FIG. 3

FIG. 7 is a cross-sectional view of the duct system, with a right side air intake, 180 from that of FIG. 3;

FIG. 8 is a front elevational view of the invention in a cabinet or locker within in a bank of cabinets or lockers;

FIG. 9 is a cross-sectional view of the duct system with the air intake in the front, placement turned 90 of that in FIGS. 3 and 7; and

FIG. 10 is a bank of cabinets or lockers shown at FIG. 8.

### DETAILED DESCRIPTION OF THE CURRENTLY PREFERRED EMBODIMENTS

A drying cabinet or locker, either an individual cabinet or locker for home use, or in a bank of lockers for use at a gym, the cabinet or locker having air circulating apparatus for enhancing the drying and deodorizing of clothing and sporting equipment not easily laundered. The air circulating apparatus includes an intake air flow fan, either battery powered or connected to an electrical circuit, an electronic controlled timing circuit permitting the fan to be set for a selected period of time, a charcoal filter element for filtering air entering a locker, and a duct system for promoting a cyclonic flow of air through the locker apparatus. An alternative embodiment includes an optional heating element and optional supplemental booster fans.

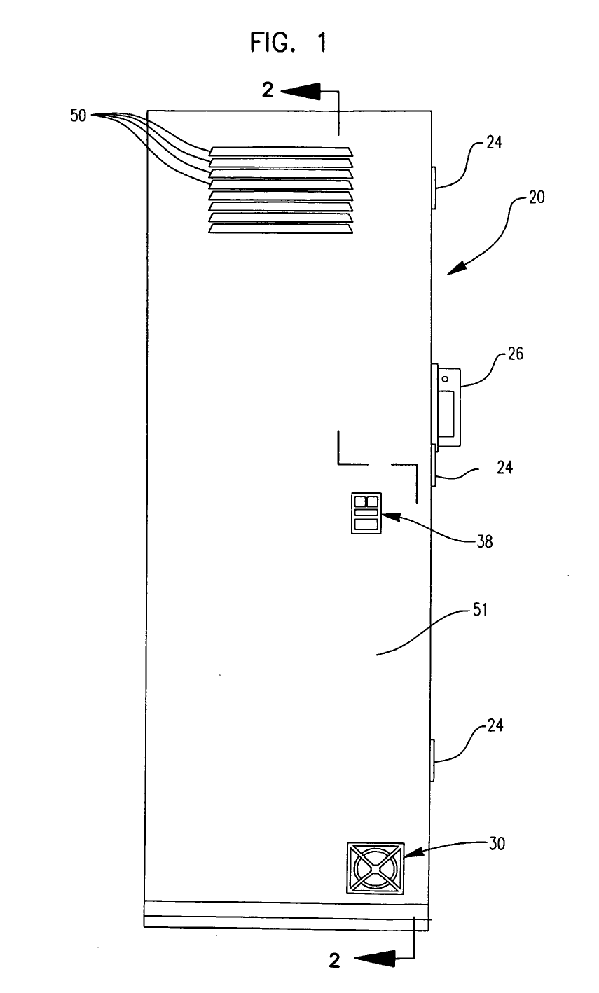

FIG. 1 is a left side view of a free-standing drying cabinet or locker 20, made as a tightly sealed four panel structure of high impact polyethylene plastic, or other similar resilient materials, with a hinged door 22 of similar materials, hinges at 24. An air intake fan assembly is provided, shown generally at 30, is either battery powered or powered by standard circuitry. In actual use conditions, an axial fan 62, such as made by Sofasco Inc. DC Cooling Fan series model having the capacity to move approximately 145 standard cubic feet per minute (scfm) has been used, although other types and sized fans could also be effective. Also indicated at FIG. 1 is the electronic timer control 38, mounted on an outside wall, the electronic timer control 38 with actual use settings of four hour, eight hour and off, which permits the fan 62 to be set to run for a predetermined period of time such as 4 hours or 8 hours although any period of time could be selected.

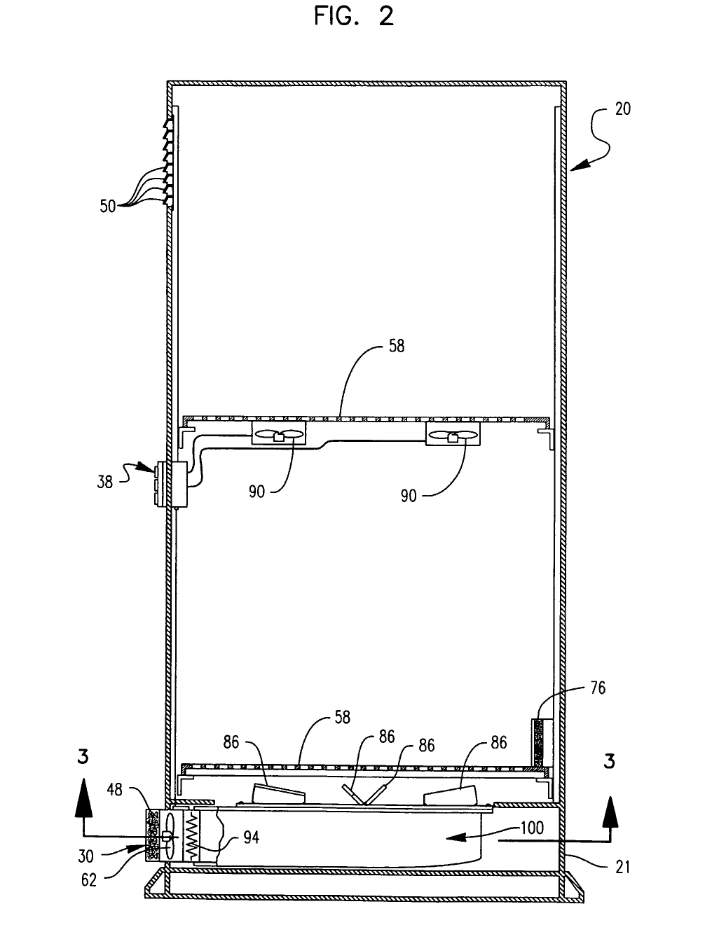

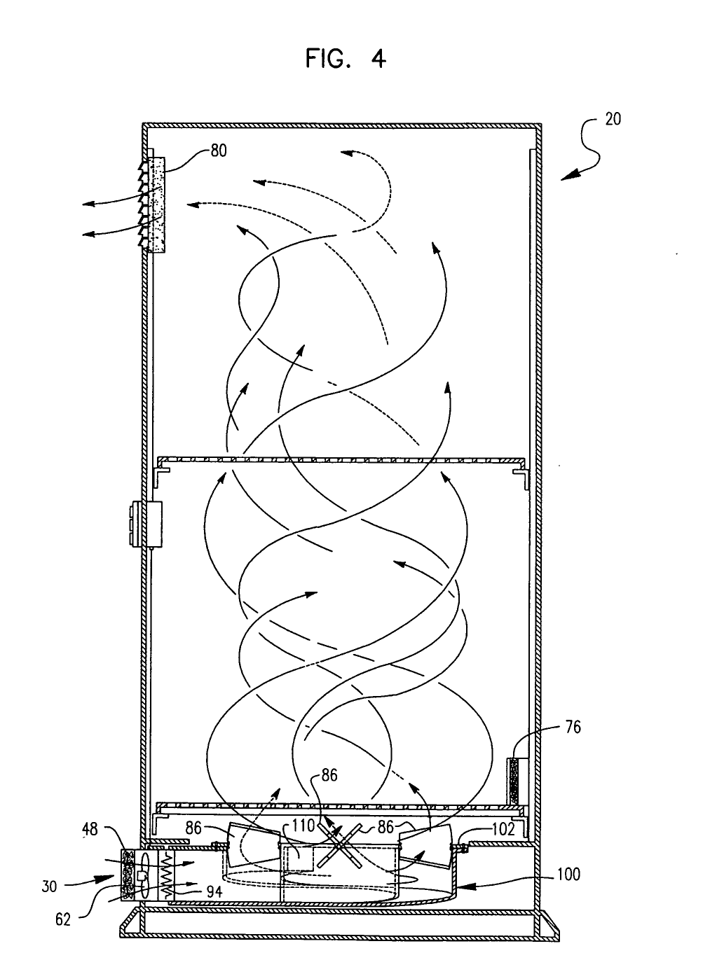

Air intake fan assembly 30 pulls air from outside the locker by fan 62, the air passing through a charcoal filter 48, pulled by fan 62, past an optional heater element 94, the airflow passing through and exiting the cyclonic duct system 100 into the drying cabinet or locker 20 where any sports equipment or clothing located on shelves 58 within the drying cabinet or locker 20 has the charcoal filtered air blowing past, drying any moisture from the sports equipment, or the like. In addition to sporting equipment, clothing of delicate fabrics and sweaters could also be dried in such a cabinet or locker. Also, the cabinet or locker could also be used for storing sporting goods such as guns in gun safes in a manner to reduce moisture within such a cabinet. Optional air heater 94, shown at FIG. 2 adds heat to decrease drying time of any damp article held within drying cabinet or locker 20. An aromatic variable vent disc housing 76, shown at FIG. 4, is used with an aromatic disc contained therein which contains natural oil compounds that are impregnated into the special fiber disc element which permits the natural oils to vaporize, in an ozone free-manner, as air circulates over the disc housing 76. In actual use conditions, an aromatic disc made by Vaprotek, Inc. has been used although other aromatic mechanisms could be used. An optional antimicrobial exhaust filter 80, also shown at FIG. 4, can also be by used in the locker to help control growth of mold, mildew, algae, fungi or the like in the discharged air.

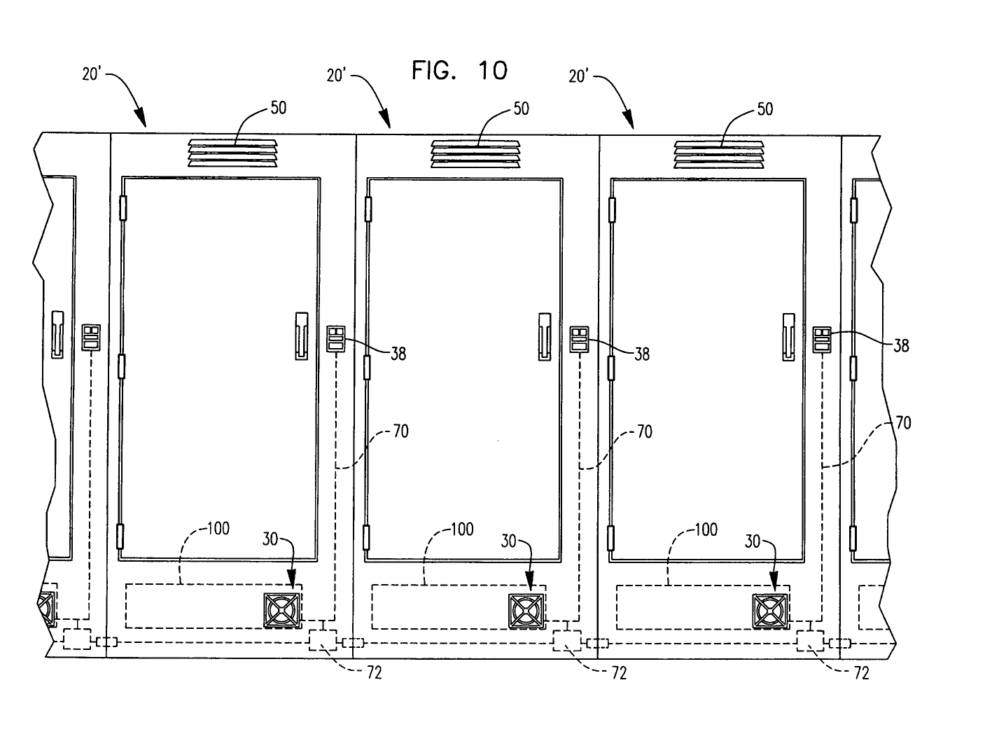

FIG. 2 is a front elevational view of the invention wherein elements of the primary invention are distributed throughout a drying cabinet or locker 20. In actual use conditions, a drying cabinet or locker 20 for home use is freestanding and contains a built-in air intake fan assembly 30, having both a charcoal filter 48, and a fan 62, with an electronic timer control 38, an optional heater 94 and an aromatic disc element 76. In actual use conditions, optional heater 94, model AF20 heater made by Famam Custom Products, has been used having 200 watt power and between 4 and 5 inches in diameter although other heaters could be used. Shelves 58 are provided to receive sporting equipment and clothing such that they are exposed to the air circulation by the air flow fan assembly 30. The air flow fan assembly 30 includes a fan 62, as described previously, having approximately 145 scfm. The fan 62, in actual use conditions, having dimensions of 4.72 inches square with a depth of 1.5 inches, 12 volts direct current (vdc), 14 watts has been used although other fan sizes powered by AC or DC voltage could be utilized. Electronic control 38, with actual use settings of four hour, eight hour and off, is provided which permits the fan to be set to run for a predetermined period of time such as 4 hours or 8 hours although any period of time could be selected. Booster fans 90 are optionally provided to increase air flow within the drying cabinet or locker 20. Handle 26, with latch, is provided to enable the door 22 of locker 20 to be tightly closed permitting the air flow to be controlled within the drying cabinet or locker 20, however, in the case of a bank of lockers, as shown in FIG. 10, a curtain could be used to enclose the space behind the curtain within the locker 20 to direct airflow within the drying cabinet or locker 20 drying and deodorizing the contents of the individual locker.

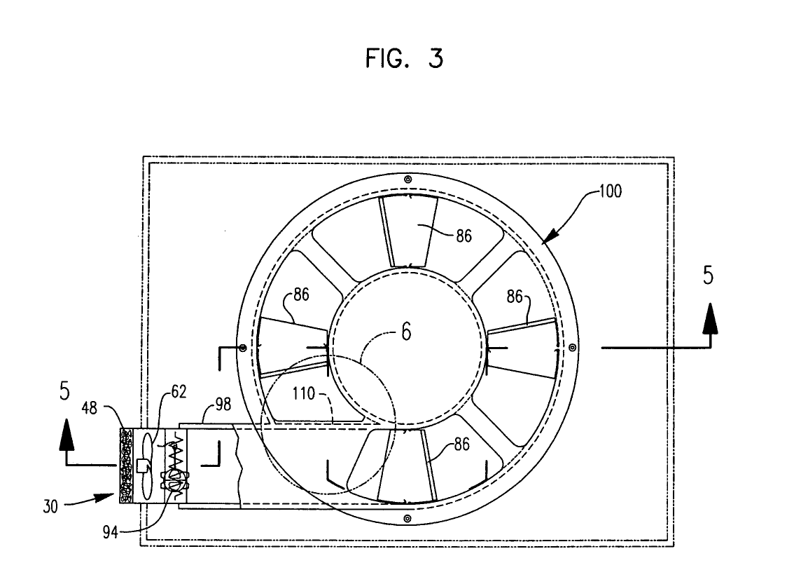

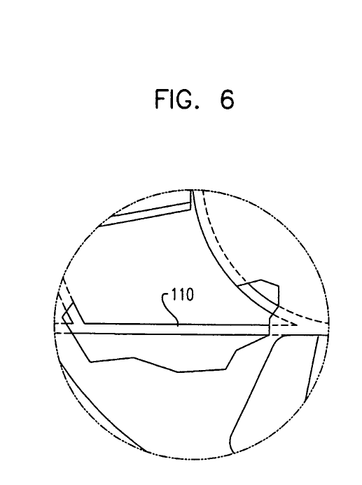

An air flow fan assembly 30 directs air into the cyclonic air-flow air ducting system, indicated at 100 in FIG. 2, which includes a circular-shaped duct that enhances the cyclonic flow of the air passing through the baffles 86 for directing airflow upwardly in a circular fashion. The cyclonic air-flow air ducting system 100 is generally circular in shape and closed on three sides with an open top. An intake air duct 98, shown at Figs., 3,4, and 7, directs air from the air flow fan assembly 30 to flow into the cyclonic air-flow air ducting system 100, which is a generally circular housing contained in the base 21 of the locker 20. The cyclonic air-flow air ducting system 100, shown in detail in FIG. 3, in actual use conditions, is a generally three-sided U-shaped duct that transitions longitudinally to a smaller sized duct and eventually to a ‘dead head’ 110, indicated at FIG. 4 and shown in detail at FIG. 6. The open side of the duct is covered by a duct cover 102 which has the baffles 86 mounted thereon, in actual use conditions the baffles 86 positioned at an approximately 45 degree angle although other angles could be used. Because the duct is reduced in size throughout its length and because of the ‘dead head’ ending, this maintains air pressure within the ducting system 100 so the air out-flow from the air ducting system 100 is a constant pressure. This reducing the size of the ducting, in actual use conditions going from approximately five inches wide and five inches high to five inches wide and three inches high, helps maintain a constant air pressure. In actual use conditions, the ducting floor raises up although other means of reducing the size of the ducting are possible. A tube-like ducting system may be also be used.

FIG. 4 is a view thereof similar to that of FIG. 2 with the locker door open, looking inside where several shelves 58 are in place for receiving sports equipment or the like, not shown. Vertical shelving as well as hooks or other devices for holding clothing open could be use, not shown. A door handle 26 is shown. In addition, optional booster fans 90 are illustrated.

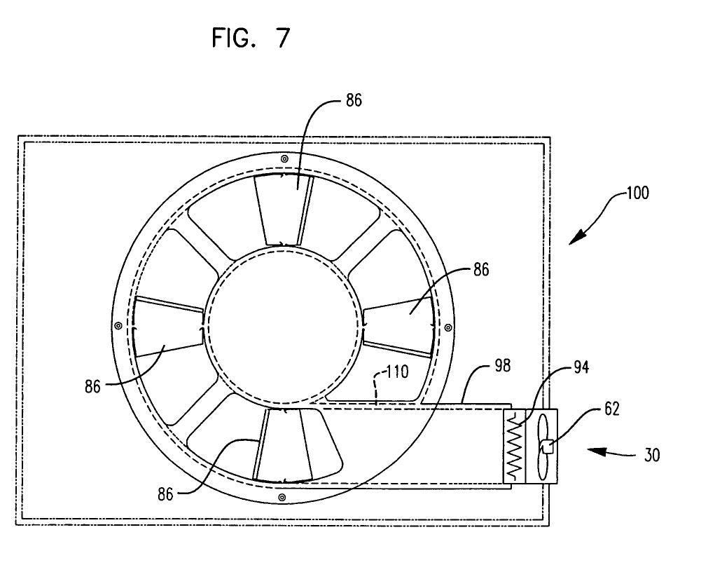

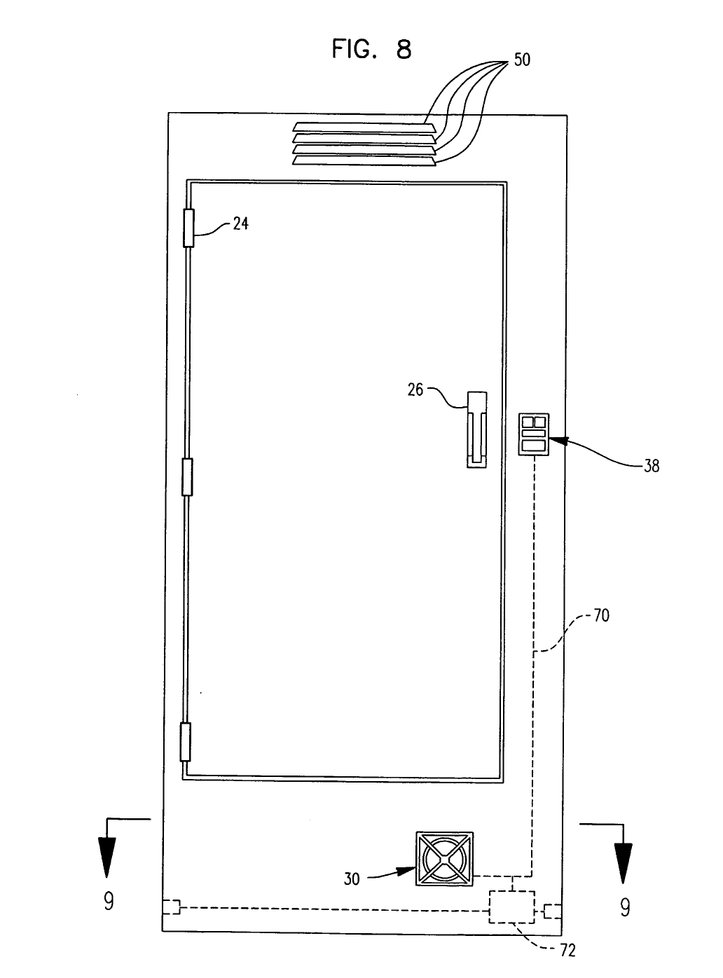

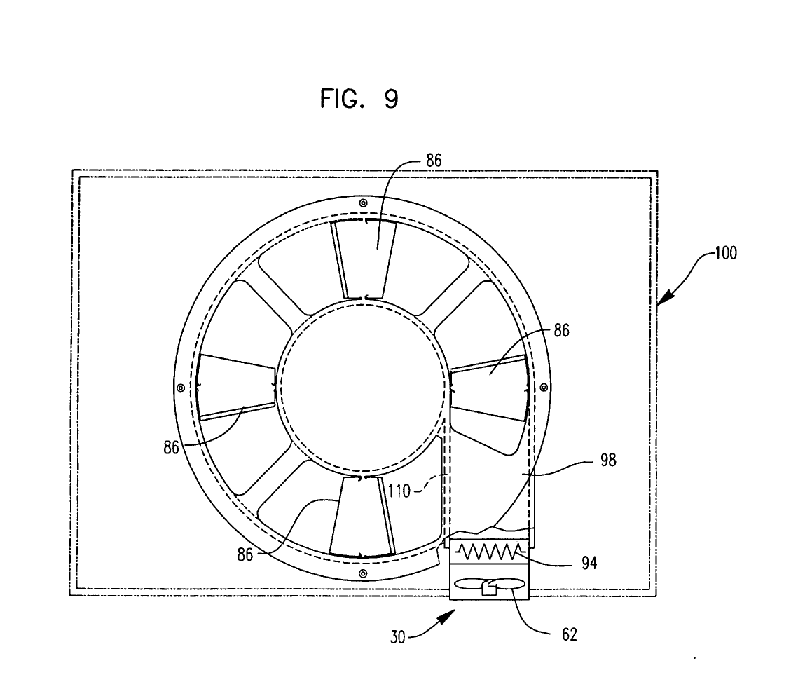

FIG. 7 illustrates the cyclonic duct system 100 of FIG. 3 mounted for air intake from the right side. FIG. 8 illustrates a drying cabinet or locker 20 having the air intake assembly 30, the electronic control 38, and the air outlet louver 50 shown on the front side of the locker 20. FIG. 9 illustrates the cyclonic duct system 100 of FIG. 8 with the air intake assembly 30 shown in the front side of the drying cabinet or locker 20.

FIG. 10 illustrates a bank of the drying cabinet or locker 20′ of FIG. 8 with a common electrical connection, junction boxes 72, each drying cabinet or locker 20′ having individual electronic control 38, air intake fan assemblies 30, cyclonic duct system 100, shown in phantom, and air outlet louvers 50.

Although the present invention has been described with reference to preferred embodiments, workers skilled in the art will recognize that changes maybe be made in form and detail without departing from the spirit and scope of the invention. For example, wheels could be added to the stand-alone locker to ease moving the locker into position. Additionally, a drip tray could be added to collect moisture coming off the sporting equipment.

What is claimed is:

1. A cabinet and locker for providing ventilation for deodorizing sporting equipment clothing and the like, comprising:
a) a built in air flow fan assembly having a fan;
b) a series of shelves for receiving sporting equipment and clothing;
c) a charcoal filter for filtering inlet air; and
d) an air flow ducting system adjacent the air flow fan assembly for proving cyclonic air flow throughout the locker.

2. The apparatus of claim 1, wherein said fan further comprises an axial fan.

3. The apparatus of claim 1, further comprising electronic controls to permit a said fan to include a timer circuit for timing operation of said fan.

4. The apparatus of claim 3, wherein said timer circuit for timing operation of said fan permits said fan to be turned on for a selected period of time and automatically shutting off.

5. The apparatus of claim 1, wherein said air flow ducting system further comprises a series of baffles for directing air flow cyclonically within the locker such that the air flow produces a centrifugal force that assists in the removal of moisture and odors from the sporting equipment and clothing.

6. The apparatus of claim 5, further comprising a heating element for drying the sporting equipment and clothing.

7. The apparatus of claim 5, further comprising a fragrance element having oil compounds that are impregnated into a fiber membrane which, when exposed to circulating air, release the oil compounds into the air neutralizing any malodorous odors.

8. The apparatus of claim 5, wherein said axial fan is battery powered.

9. The apparatus of claim 7, wherein said axial fan is powered by circuitry.

10. A cabinet and locker for providing equipment locker ventilation for deodorizing sporting equipment clothing and the like, comprising:
a) a built in air flow fan assembly having a fan;
b) a series of shelves for receiving sporting equipment and clothing;
c) a charcoal filter for filtering inlet air;
d) an air flow ducting system adjacent the air flow fan assembly for proving cyclonic air flow throughout the locker; and
e) electronic controls to permit a said fan to include a timer circuit for timing operation of said fan.

11. The apparatus of claim 10, wherein said fan further comprises an axial fan.

12. The apparatus of claim 10, wherein said timer circuit for timing operation of said fan permits said fan to be turned on for a selected period of time and automatically shutting off.

13. The apparatus of claim 10, wherein said air flow ducting system further comprises a series of baffles for directing air flow cyclonically within the locker such that the air flow produces a centrifugal force that assists in the removal of moisture and odors from the sporting equipment and clothing.

14. The apparatus of claim 10, further comprising a heating element for drying the sporting equipment and clothing.

15. The apparatus of claim 5, further comprising a fragrance element having oil compounds that are impregnated into a fiber membrane which, when exposed to circulating air, release the oil compounds into the air neutralizing any malodorous odors.

16. The apparatus of claim 11, wherein said axial fan is battery powered.

17. The apparatus of claim 11, wherein said axial fan is powered by circuitry.

18. A cabinet and locker for providing ventilation for deodorizing sporting equipment clothing and the like, comprising:
a) a built in air flow fan assembly having a fan;
b) a series of shelves for receiving sporting equipment and clothing;
c) a charcoal filter for filtering inlet air;
d) an air flow ducting system adjacent the air flow fan assembly for proving cyclonic air flow throughout the locker;
e) electronic controls to permit a said fan to include a timer circuit for timing operation of said fan;
f) said timer circuit for timing operation of said fan permits said fan to be turned on for a selected period of time and automatically shutting off.

19. The apparatus of claim 18, wherein said air flow ducting system further comprises a series of baffles for directing air flow cyclonically within the locker such that the air flow produces a centrifugal force that assists in the removal of moisture and odors from the sporting equipment and clothing.

20. The apparatus of claim 19, further comprising a heating element for drying the sporting equipment and clothing.

21. The apparatus of claim 19, further comprising a fragrance element having oil compounds that are impregnated into a fiber membrane which, when exposed to circulating air, release the oil compounds into the air neutralizing any malodorous odors.
